(19) United States
(12) Patent Application Publication
(10) Pub. No.: US 2017/0137567 A1
(43) Pub. Date: May 18, 2017

(54) TERMINALLY MODIFIED POLYETHYLENE TEREPHTHALATE RESIN, METHOD OF PRODUCING SAME AND MOLDED ARTICLE

(71) Applicant: Toray Industries, Inc., Tokyo (JP)

(72) Inventors: Tsuyoshi Tanaka, Nagoya (JP); Yuka Sato, Nagoya (JP); Takuro Okubo, Nagoya (JP); Koya Kato, Nagoya (JP)

(21) Appl. No.: 15/310,027

(22) PCT Filed: Jun. 1, 2015
(86) PCT No.: PCT/JP2015/065741

§ 371 Date: Nov. 9, 2016

(30) Foreign Application Priority Data
Jun. 4, 2014 (JP) 2014-115484

(51) Int. Cl. C08G 63/672; C08J 5/18; C08G 63/80

(52) U.S. Cl. CPC C08G 63/672; C08G 63/80; C08J 5/18; C08J 2367/02

(57) ABSTRACT

A terminal modified polyethylene terephthalate resin has an intrinsic viscosity of 0.5 to 1.8 dl/g, a melting point of 245° C. to 270° C., and a melt viscosity μ(Pa·s) at 300° C. and satisfies inequality (A): μ≦4×e^{(0.000085×Mw)} (A) wherein Mw represents a weight average molecular weight relative to a molecular weight of standard polymethyl methacrylate, as determined by gel permeation chromatography using hexafluoroisopropanol (with 0.005 N sodium trifluoroacetate added) as a mobile phase, the terminal modified polyethylene terephthalate resin including 25 to 80 mol/ton of a compound having a (poly)oxyalkylene structure and bound to a terminal, the compound represented by formula (B):

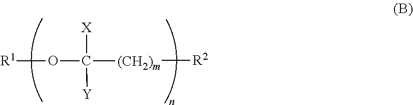

### TECHNICAL FIELD

This disclosure relates to a terminal modified polyethylene terephthalate resin having a low melt viscosity, high melt stability, and a high melting point, a method of producing the resin, and a molded article made of the resin.

### BACKGROUND

Polyesters, because of their functionality, have been used for clothing, materials, medical applications and other applications. Among polyesters, polyethylene terephthalate (PET) is highly versatile and practical, and PET can be melt processed into films, sheets, fibers, injection-molded articles and other forms to be used. PET is typically produced from terephthalic acid or an ester-forming derivative thereof and ethylene glycol, and it is known that higher polymers have higher melt viscosities. Reducing the melt viscosity reduces the shear heating during melt processing, which enables reduced thermal decomposition, lower melt-processing temperatures, and the production of molded articles of complex shape. That contributes to melt stability improvement, environmental load reduction and moldability improvement.

In JP 62-90312 A, PET is copolymerized with mono-endcapped polyoxyalkylene glycol to improve antifouling property and washing durability.

In JP 2004-99729 A, PET is reacted with an epoxy compound, which has ether linkage, during melt extrusion to provide flexibility.

Synthesis and characterization of poly(ethylene glycol)methyl ether endcapped poly(ethylene terephthalate) written by Timothy E. Long, published by Macromolecular Symposia, October 2003, volume 199, issue 1, p. 163-172 discloses a PET resin obtained by adding methyl ether endcapped poly(ethylene glycol) (MPEG) during PET polymerization.

The technique in JP 62-90312 A is disadvantageous in that when the degree of polymerization of polyoxyalkylene glycol is high, the molecular weight significantly decreases during melting.

The technique in JP 2004-99729 A is disadvantageous in that epoxy groups react with carboxyl groups of PET to faun pendant hydroxyl groups in the PET molecule, and these hydroxyl groups further react with carboxyl groups of the PET, resulting in gelation.

The technique in Synthesis and characterization of poly(ethylene glycol) methyl ether endcapped poly(ethylene terephthalate) written by Timothy E. Long, published by Macromolecular Symposia, October 2003, volume 199, issue 1, p. 163-172 is disadvantageous in that the PET resin obtained is a low polymer and has a low melting point and low mechanical properties. In addition, the PET resin disadvantageously gels through the introduction of a branched backbone.

It could therefore be helpful to provide a terminal modified polyethylene terephthalate resin having a low melt viscosity, high melt stability and a high melting point.

### SUMMARY

We thus provide:

Our terminal modified polyethylene terephthalate resin has the following structure:

A terminal modified polyethylene terephthalate resin having an intrinsic viscosity of 0.50 to 1.8 dl/g, a melting point of 245° C. to 270° C., and a melt viscosity μ(Pa·s) at 300° C. satisfies inequality (A) and comprises 25 to 80 mol/ton of a compound bound to a terminal, the compound being represented by formula (B).

μ≦4 ×e^{(0.000085×Mw)} (A)

wherein Mw represents a weight average molecular weight relative to a molecular weight of standard polymethyl methacrylate as determined by gel permeation chromatography using hexafluoroisopropanol (with 0.005 N sodium trifluoroacetate added) as a mobile phase.

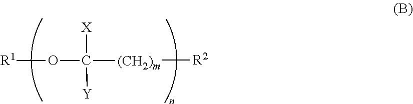

The compound has a (poly)oxyalkylene structure, and in formula (B), R¹ is at least one selected from alkyl groups of 1 to 30 carbon atoms, cycloalkyl groups of 6 to 20 carbon atoms, aryl groups of 6 to 10 carbon atoms, and aralkyl groups of 7 to 20 carbon atoms; R² is one selected from a hydroxyl group, a carboxyl group, an amino group, a silanol group, and a thiol group; m is an integer of 1 to 3; n is an integer of 1 to 29; X is H and/or CH₃; and Y is H and/or CH₃, provided that the total number of carbons excluding the carbons of R¹ and R² is 2 to 58.

The terminal modified polyethylene terephthalate resin preferably has a crystal melting enthalpy of 45 to 80 J/g, the crystal melting enthalpy being determined by differential scanning calorimetry (DSC) in which the resin is heated from 30° C. to 280° C. at a heating rate of 10° C./min, held at 280° C. for 3 minutes, cooled from 280° C. to 30° C. at a cooling rate of 200° C./min, and heated from 30° C. to 280° C. at a heating rate of 10° C./min.

The terminal modified polyethylene terephthalate resin preferably has a peak top temperature of an exothermic peak of 170° C. to 210° C., the peak top temperature being determined by differential scanning calorimetry (DSC) in which the resin is heated from 30° C. to 280° C. at a heating rate of 10° C./min, held at 280° C. for 3 minutes, and then cooled from 280° C. to 30° C. at a cooling rate of 200° C./min.

The terminal modified polyethylene terephthalate resin preferably has an acid value of 13 mol/ton or less.

The terminal modified polyethylene terephthalate resin preferably has a rate of change in weight average molecular weight of 80% to 120%, the rate of change being deteimined after the resin is melted under nitrogen at 280° C. for 15 minutes using a rheometer and then oscillated at a frequency of 0.5 to 3.0 Hz and an amplitude of 20%.

The terminal modified polyethylene terephthalate resin preferably has a polydispersity (Mw/Mn), a ratio of weight average molecular weight (Mw) to number average molecular weight (Mn), of 2.5 or less.

The molded article has the following structure:

A molded article comprises the above-described terminal modified polyethylene terephthalate resin.

The molded article is preferably a molded article in the form of a fiber or a film comprising the above-described terminal modified polyethylene terephthalate resin.

A method of producing the terminal modified polyethylene terephthalate resin has the following structure:

A method of producing a terminal modified polyethylene terephthalate resin from raw materials comprises a compound represented by formula (B), ethylene glycol, and terephthalic acid or a terephthalic acid dialkyl ester, the method comprising:

a first step comprising an esterification reaction process (a) or a transesterification reaction process (b); and

a subsequent second step comprising a polycondensation reaction process (c).

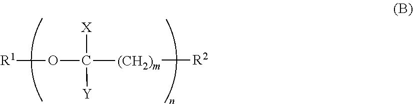

The compound has a (poly)oxyalkylene structure, and in formula (B), R¹ is at least one selected from alkyl groups of 1 to 30 carbon atoms, cycloalkyl groups of 6 to 20 carbon atoms, aryl groups of 6 to 10 carbon atoms, and aralkyl groups of 7 to 20 carbon atoms; R² is one selected from a hydroxyl group, a carboxyl group, an amino group, a silanol group, and a thiol group; m is an integer of 1 to 3; n is an integer of 1 to 29; X is H and/or CH₃; and Y is H and/or CH₃, provided that the total number of carbons excluding the carbons of R¹ and R² is 2 to 58.

In the method of producing a terminal modified polyethylene terephthalate resin, the compound represented by formula (B) is preferably added in any process selected from the esterification reaction process (a), the transesterification reaction process (b), and the polycondensation reaction process (c).

In the method of producing a terminal modified polyethylene terephthalate resin, the compound represented by formula (B) is preferably added in the esterification reaction process (a) or the transesterification reaction process (b) and allowed to react at 230° C. to 260° C.

In the method of producing a terminal modified polyethylene terephthalate resin, the polycondensation reaction process (c) is preferably performed at a maximum temperature of 280° C. to 300° C.

The method of producing a terminal modified polyethylene terephthalate resin preferably further comprises subjecting the terminal modified polyethylene terephthalate resin obtained by the polycondensation reaction process (c) to solid phase polymerization at a temperature of 200° C. to 240° C.

The method of producing a terminal modified polyethylene terephthalate resin preferably provides the above-described terminal modified polyethylene terephthalate resin.

We provide a terminal modified polyethylene terephthalate resin having a low melt viscosity, high melt stability, and a high melting point.

### BRIEF DESCRIPTION OF THE DRAWING

FIG. 1 is a graph showing the relationship between the weight average molecular weight and the melt viscosity of the terminal modified polyethylene terephthalate resin.

### DETAILED DESCRIPTION

The major diol component of the polyethylene terephthalate resin moiety of a terminal modified polyethylene terephthalate resin is ethylene glycol, and the major dicarboxylic acid component is at least one selected from terephthalic acid and dialkyl esters thereof. The major diol component means that the amount of ethylene glycol is at least 80 mol % of all diol components in the terminal modified polyethylene terephthalate. The major dicarboxylic acid component means that the amount of terephthalic acid and dialkyl esters thereof is at least 80 mol % of all dicarboxylic acid components in the teuiiinal modified polyethylene terephthalate.

The terminal modified polyethylene terephthalate resin may contain copolymerization components to the extent that the desired effects are substantially not adversely affected, and examples of the copolymerization components include compounds having two polymerizable functional groups, including aromatic dicarboxylic acids such as isophthalic acid, 5-sulfoisophthalic acid salts, phthalic acid, naphthalene-2,6-dicarboxylic acid, and bisphenol dicarboxylic acid, and dialkyl esters thereof; aliphatic dicarboxylic acids such as succinic acid, adipic acid, pimelic acid, suberic acid, azelaic acid, sebacic acid, 1,9-nonanedicarboxylic acid, and 1,12-dodecanedicarboxylic acid, and dialkyl esters thereof; and diol components such as propanediol, butanediol, pentanediol, hexanediol, 2-methyl-1,3-propanediol, and bisphenol A-ethylene oxide adduct. These compounds may be contained in an amount of 10% by weight or less based on all the monomer components in the polyethylene terephthalate resin. These compounds can be used alone or in a combination of two or more. Examples of dicarboxylic acid dialkyl esters include dimethyl dicarboxylate and diethyl dicarboxylate. Preferred copolymerization components are the above-described compounds having two polymerizable functional groups. Compounds having more than two polymerizable functional groups such as trimethyl 1,3,5-benzenetricarboxylate, act as a cross-linking point and thus tend to provide a polymer having a low melting point and low melt stability. The weight of compounds having more than two polymerizable functional groups in the polymer is preferably 0.8% by weight or less, more preferably 0.5% by weight or less, still more preferably 0% by weight.

The terminal modified polyethylene terephthalate resin is required to have an intrinsic viscosity as measured at 25° C. using an o-chlorophenol solvent of 0.50 to 1.8. The intrinsic viscosity is preferably 0.55 or more, more preferably 0.60 or more. The intrinsic viscosity is preferably 1.5 or less, more preferably 1.4 or less. An intrinsic viscosity of less than 0.50 disadvantageously results in reduced mechanical properties. An intrinsic viscosity of more than 1.8 disadvantageously necessitates adding an excessive thermal history in producing the terminal modified polyethylene terephthalate resin, leading to polymer degradation.

The terminal modified polyethylene terephthalate resin preferably, but not necessarily, has a weight average molecular weight (Mw) of 15,000 or more in terms of mechanical properties. The weight average molecular weight is more preferably 20,000 or more, still more preferably 25,000 or more. To prevent thermal degradation during the production, the weight average molecular weight is preferably 200,000 or less, more preferably 180,000 or less, still more preferably 150,000 or less. The weight average molecular weight can be determined by gel permeation chromatography (GPC) at 30° C. using a hexafluoroisopropanol solvent and a column consisting of two Shodex GPC HFIP-806M columns and a Shodex GPC HFIP-LG column connected in series. The weight average molecular weight is a value relative to the molecular weight of standard polymethyl methacrylate. The number average molecular weight described below is also determined by this method.

The terminal modified polyethylene terephthalate resin is required to have a melting point of 245° C. to 270° C. To achieve high melt processability, the melting point is preferably 245° C. to 265° C., more preferably 250° C. to 265° C. A melting point of lower than 245° C. disadvantageously results in low heat resistance. A melting point of higher than 270° C. disadvantageously results in extremely increased crystallinity and crystal size to necessitate excessive heating during melt processing, causing polymer decomposition. The melting point of the terminal modified polyethylene terephthalate resin is a peak top temperature of an endothermic peak observed by differential scanning calorimetry (DSC) in which the resin is heated from 30° C. to 280° C. at a heating rate of 10° C./min, held at 280° C. for 3 minutes, cooled from 280° C. to 30° C. at a cooling rate of 200° C./min, and then heated from 30° C. to 280° C. at a heating rate of 10° C./min.

The area of the above-described endothermic peak represents a crystal melting enthalpy. The crystal melting enthalpy, to achieve high heat resistance, is preferably 45 J/g or more, more preferably 50 J/g or more, and to achieve high melt processability, preferably 80 J/g or less, more preferably 70 J/g or less. The crystal melting enthalpy can be high when the amount of ethylene glycol is at least 80 mol % of all diol components in the terminal modified polyethylene terephthalate resin, and the amount of terephthalic acid and alkyl esters thereof is at least 80 mol % of all dicarboxylic acid components.

Furthermore, the terminal modified polyethylene terephthalate resin preferably has a cold crystallization temperature of 170° C. or higher to achieve high crystallinity. The cold crystallization temperature is a peak top temperature of an exothermic peak observed by differential scanning calorimetry (DSC) in which the resin is heated from 30° C. to 280° C. at a heating rate of 10° C./min, held at 280° C. for 3 minutes, and then cooled from 280° C. to 30° C. at a cooling rate of 200° C./min The cold crystallization temperature is more preferably 175° C. or higher, still more preferably 180° C. or higher. The cold crystallization temperature is preferably not higher than 210° C. because a cold crystallization temperature higher than 210° C. tends to lead to a strong intermolecular interaction and a small reduction effect of melt viscosity. The cold crystallization temperature is more preferably 205° C. or lower, still more preferably 200° C. or lower.

The terminal modified polyethylene terephthalate resin is required to have a melt viscosity μ(Pa·s) at 300° C. that satisfies inequality (A).

μ≦4×e^{(0.000085×Mw)} (A)

wherein Mw represents a weight average molecular weight relative to a molecular weight of standard polymethyl methacrylate, as determined by gel permeation chromatography using hexafluoroisopropanol (with 0.005 N sodium trifluoroacetate added) as a mobile phase.

The melt viscosity μ(Pa·s) at 300° C. refers to a melt viscosity μ(Pa·s) of the resin melted at 300° C. for 5 minutes in a nitrogen atmosphere, as determined using a rheometer (MCR501 available from Anton Paar) in the oscillatory mode at a frequency of 3.0 Hz and an amplitude of 20%.

We confirmed that the melt viscosity μ(Pa·s) of terminal unmodified polyethylene terephthalate determined under the same conditions as above is represented by approximate expression (C).

9.4×e^{(0.000082×Mw)}≦μ≦10.4×e^{(0.000082×Mw)} (C)

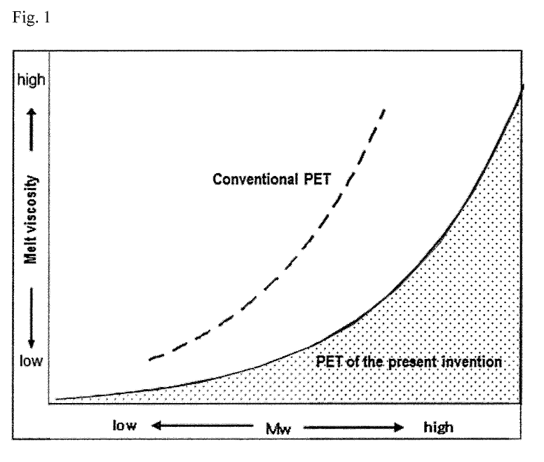

The terminal modified polyethylene terephthalate resin is characterized by having a melt viscosity significantly lower than that of a terminal unmodified polyethylene terephthalate resin. FIG. 1 schematically shows the relationships between the weight average molecular weight (Mw) and the melt viscosity of a terminal unmodified polyethylene terephthalate resin and the terminal modified polyethylene terephthalate resin.

To achieve high melt processability, the melt viscosity preferably satisfies inequality (D), more preferably satisfies inequality (E).

μ≦3×e^{(0.000085×Mw)} (D)

μ≦2×e^{(0.000085×Mw)} (E)

When the melt viscosity μ is larger than the right-hand side of the inequality (A), the difference from a terminal unmodified polyethylene terephthalate resin is small, and the reduction effect of melt viscosity is not sufficient. There is no lower limit to the melt viscosity μ, and the lower the melt viscosity μ is, the more the melt processability improves.

The polyethylene terephthalate resin is required to include 25 to 80 mol/ton of a compound bound to a terminal, the compound being represented by formula (B).

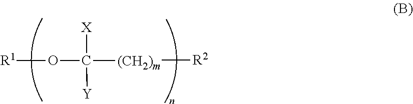

The compound has a (poly)oxyalkylene structure, and in formula (B), R¹ is at least one selected from alkyl groups of 1 to 30 carbon atoms, cycloalkyl groups of 6 to 20 carbon atoms, aryl groups of 6 to 10 carbon atoms, and aralkyl groups of 7 to 20 carbon atoms; R² is one selected from a hydroxyl group, a carboxyl group, an amino group, a silanol group, and a thiol group; m is an integer of 1 to 3; n is an integer of 1 to 29; X is H and/or CH₃; and Y is H and/or CH₃, provided that the total number of carbons excluding the carbons of R¹ and R² is 2 to 58.

Less than 25 mol/ton of the compound represented by formula (B) bound to the polyethylene terephthalate resin terminal disadvantageously produces a small reduction effect of melt viscosity, and more than 80 mol/ton of the compound represented by formula (B) bound to the polyethylene terephthalate resin terminal disadvantageously makes it difficult to increase the molecular weight.

The compound represented by formula (B) having a (poly)oxyalkylene structure is known to have an ether linkage, which has high molecular mobility, and a solubility parameter similar to that of polyethylene terephthalate, thus having high compatibility. Thus, the compound having a (poly)oxyalkylene structure can reduce the intermolecular interaction of the polyethylene terephthalate molecular chain during melting and increase the free volume, significantly increasing the molecular mobility of the polymer chain. As a result, a significant reduction effect of melt viscosity is produced.

R¹ of the compound (B) is required to be at least one selected from alkyl groups of 1 to 30 carbon atoms, cycloalkyl groups of 6 to 20 carbon atoms, aryl groups of 6 to 10 carbon atoms, and aralkyl groups of 7 to 20 carbon atoms. Specific examples include methyl, ethyl, propyl, butyl, pentyl, hexyl, heptyl, and octyl. Examples of cycloalkyl groups of 6 to 20 carbon atoms include cyclohexyl, cyclopentyl, cyclooctyl, and cyclodecyl. Examples of aryl groups of 6 to 10 carbon atoms include phenyl, tolyl, dimethylphenyl, and naphthyl. Examples of aralkyl groups of 7 to 20 carbon atoms include benzyl, phenethyl, methylbenzyl, 2-phenylpropan-2-yl, and diphenylmethyl. R¹ is preferably an alkyl group of 1 to 30 carbon atoms, particularly preferably a methyl group.

R² of the compound (B) is required to be a functional group bindable to the polyethylene terephthalate resin and selected from a hydroxyl group, a carboxyl group, an amino group, a silanol group, and a thiol group. In terms of high reactivity with the polyethylene terephthalate resin, hydroxyl and carboxyl are preferred.

m of the compound (B) is required to be an integer of 1 to 3 to achieve high heat resistance. m is preferably an integer of 1 to 2, more preferably 1. When m is 3 or less, the proportion of the ether linkage in the terminal portion is large, which can increase the reduction effect of melt viscosity.

n of the compound (B) is required to be an integer of 1 to 29 to achieve a high reduction effect of melt viscosity and high melt stability. n is preferably an integer of 3 or more, more preferably an integer of 5 or more. n is preferably an integer of 27 or less, more preferably an integer of 25 or less.

X of the compound (B) is required to be H and/or CH₃. When X is H and/or CH₃, the affinity for the polyethylene terephthalate moiety, the main backbone, is high, which can increase the reduction effect of melt viscosity.

Y of the compound (B) is required to be H and/or CH₃. When Y is H and/or CH₃, the affinity for the polyethylene terephthalate moiety, the main backbone, is high, which can increase the reduction effect of melt viscosity.

The total number of carbons in the oxyalkylene structure of the compound (B), excluding the carbons of R¹ and R², is required to be 2 to 58. When the total number of carbons in the oxyalkylene structure, excluding the carbons of R¹ and R², is 2 to 58, a terminal modified polyethylene terephthalate resin having a high reduction effect of melt viscosity and high melt stability can be obtained.

The concentration of the compound represented by formula (B) having a (poly)oxyalkylene structure and bound to a terminal of the polyethylene terephthalate resin is required to be 25 to 80 mol/ton. To increase the reduction effect of melt viscosity, the concentration is preferably 30 mol/ton or more, more preferably 35 mol/ton or more. To increase the molecular weight of the terminal modified polyethylene terephthalate resin, the concentration is preferably 75 mol/ton or less, more preferably 70 mol/ton or less.

The weight percentage of the compound represented by formula (B) having a (poly)oxyalkylene structure and bound to a terminal of the polyethylene terephthalate resin is preferably at least 0.5% by weight. At least 0.5% by weight of the compound can increase the reduction effect of melt viscosity. The weight percentage is more preferably 1.5% by weight or more, still more preferably 3.0% by weight or more. To increase the molecular weight of the terminal modified polyethylene terephthalate resin, the weight percentage is preferably 7.0% by weight or less, more preferably 5.0% by weight or less, still more preferably 4.0% by weight or less.

In the terminal modified polyethylene terephthalate resin, a specific amount of the compound represented by formula (B) having a (poly)oxyalkylene structure is required to be bound to a polymer terminal. The compound represented by formula (B) bound to a polymer terminal can improve the molecular mobility during melting to significantly reduce the melt viscosity, without adversely affecting the crystallinity of the polyethylene terephthalate resin, the main backbone.

When the compound having a (poly)oxyalkylene structure is bound mainly within the backbone, as compared to when the compound is bound mainly to a terminal, both terminals of the (poly)oxyalkylene structure are constrained, as a result of which a sufficient molecular-mobility-improving effect tends not to be produced. In addition, the cold crystallization temperature tends to be low, leading to low crystallinity.

The terminal modified polyethylene terephthalate resin has a low melt viscosity and undergoes less shear heating and less decomposition during polymerization, thus resulting in less formation of carboxyl groups. The terminal modified polyethylene terephthalate resin preferably has an acid value (carboxyl group concentration) of 13 mol/ton or less to achieve high hydrolysis resistance. Although there is no lower limit to the acid value, it is more preferably 11 mol/ton or less, still more preferably 9 mol/ton or less. The hydrolysis resistance can be evaluated by determining a weight average molecular weight retention by dividing a weight average molecular weight of the terminal modified polyethylene terephthalate resin that has been treated under the conditions of 121° C. and 100% RH for 24 hours by a weight average molecular weight of the resin that has not been treated. The weight average molecular weight retention is preferably 60% or more, more preferably 70%. The weight average molecular weight can be determined by gel permeation chromatography as described above.

The terminal modified polyethylene terephthalate resin preferably has a rate of change in weight average molecular weight of 80% to 120%, the rate of change being determined after the resin is melted under nitrogen at 280° C. for 15 minutes using a rheometer and then oscillated at a frequency of 0.5 to 3.0 Hz and an amplitude of 20%. Within this range, the change in viscosity during melting can be minimized, which enables stable melt processing. The rate of change is more preferably 85% to 115%, still more preferably 90% to 110%.

The terminal modified polyethylene terephthalate resin preferably has a polydispersity (Mw/Mn), a ratio of weight average molecular weight (Mw) to number average molecular weight (Mn), of 2.5 or less, more preferably 2.3 or less, still more preferably 2.0 or less. The terminal modified polyethylene terephthalate resin, for its low melt viscosity, tends to polymerize more uniformly in melt polymerization and have a small polydispersity. Although there is no lower limit to the polydispersity, it is theoretically at least 1.0. A polydispersity of more than 2.5 tends to result in reduced mechanical properties such as toughness, because the amount of low-molecular-weight component is relatively large.

The terminal modified polyethylene terephthalate resin, for its low melt viscosity, can readily be processed into injection-molded articles, fibers, films and other products. This effect allows the terminal modified polyethylene terephthalate resin to be processed at low temperatures, which can reduce thermal energy, leading to a reduced environmental load. With regard to injection-molded articles, it has been difficult to mold articles of complex shape because of high molecular weights. However, such molded articles of complex shape can readily be obtained by using the terminal modified polyethylene terephthalate resin.

With regard to fibers, it has been difficult to perform melt spinning because of a melt viscosity increasing with increasing molecular weight. However, the terminal modified polyethylene terephthalate resin makes it easy to perform melt spinning of high-molecular-weight polymers and undergoes less shear heating during melting to avoid decomposition, thus providing fibers with high strength.

Also with regard to films, similarly to the fibers, it has been difficult to perform melt film formation because of a melt viscosity increasing with increasing molecular weight. However, the terminal modified polyethylene terephthalate resin makes it easy to perform melt film formation of high-molecular-weight polymers and undergoes less shear heating during melting to avoid decomposition, thus providing films with high strength.

A description will now be given of a method of producing the terminal modified polyethylene terephthalate resin.

A method of producing the terminal modified polyethylene terephthalate resin using, as raw materials, a dicarboxylic acid and/or a dicarboxylic acid dialkyl ester, a diol, and the compound represented by formula (B) includes the following two steps: a first step comprising an esterification reaction process (a) or a transesterification reaction process (b) and a subsequent second step comprising a polycondensation reaction process (c).

In the first step, the esterification reaction process (a) is a process in which a dicarboxylic acid and a diol are allowed to undergo esterification reaction at a predetermined temperature until a predetermined amount of water is evaporated to give a low polycondensate. The transesterification reaction process (b) is a process in which a dicarboxylic acid dialkyl ester and a diol are allowed to undergo transesterification reaction at a predetermined temperature until a predetermined amount of alcohol is evaporated to give a low polycondensate.

The second step, that is, the polycondensation reaction (c), is a process in which the low polycondensation obtained in the esterification reaction (a) or the transesterification reaction (b) is heated under reduced pressure to undergo de-diolation reaction, thereby obtaining a terminal modified polyethylene terephthalate resin.

In the method of producing the terminal modified polyethylene terephthalate resin, to quantitatively introduce the compound of formula (B) into a polymer terminal, the compound is preferably added at any timing selected from the process (a) or (b) and the subsequent process (c). The compound is more preferably added in the process (a) or (b). Although the terminal modified polyethylene terephthalate resin can also be produced by melt-kneading a terminal unmodified polyethylene terephthalate resin and the compound of formula (B) in an extruder, the compound of formula (B) is introduced into a polyethylene terephthalate terminal in a smaller amount, and the compound of formula (B) left unreacted tends to bleed out during heat treatment.

In the method of producing the terminal modified polyethylene terephthalate resin, the maximum temperature in the esterification reaction process (a) or the transesterification reaction process (b) is preferably 230° C. or higher. A maximum temperature of 230° C. or higher can ensure that the compound of formula (B), when added in the process (a) or (b), sufficiently reacts with polyethylene terephthalate components, leading to quantitative introduction into a polymer terminal. The maximum temperature is more preferably 235° C. or higher, still more preferably 240° C. or higher. The maximum temperature is preferably 260° C. or lower. A maximum temperature of 260° C. or lower can prevent or reduce the thermal decomposition and volatilization of the compound of formula (B) added in the process (a) or (b). The maximum temperature is preferably 255° C. or lower, more preferably 250° C. or lower.

In the method of producing the terminal modified polyethylene terephthalate resin, the maximum temperature in the polycondensation reaction process is preferably 280° C. or higher. A maximum temperature of 280° C. or higher can facilitate polymerization. The maximum temperature is more preferably 285° C. or higher. The maximum temperature in the polycondensation reaction process is preferably 300° C. or lower. A maximum temperature of 300° C. or lower can prevent or reduce the thermal decomposition of the terminal modified polyethylene terephthalate resin. The maximum temperature is more preferably 295° C. or lower.

To produce a terminal modified polyethylene terephthalate resin with an even higher molecular weight, it is preferable to subject the terminal modified polyethylene terephthalate resin obtained by the above-described method further to solid phase polymerization. The solid phase polymerization may be carried out using any given apparatus by heat-treating the resin in an inert gas atmosphere or under reduced pressure. The inert gas may be any gas inactive against polyethylene terephthalate. Examples include nitrogen, helium, and carbonic acid gas, and nitrogen is suitable for use. For the reduced pressure conditions, the pressure in the apparatus is preferably set to 133 Pa or lower, and the pressure is preferably as low as possible to shorten the solid phase polymerization time.

In the method of producing the terminal modified polyethylene terephthalate resin, the maximum temperature of the solid phase polymerization is preferably 200° C. or higher. A maximum temperature of 200° C. or higher can facilitate polymerization. The maximum temperature is more preferably 210° C. or higher, still more preferably 220° C. or higher. The maximum temperature of the solid phase polymerization is preferably 240° C. or lower. A maximum temperature of 240° C. or lower can prevent or reduce thermal decomposition. The maximum temperature is more preferably 235° C. or lower, still more preferably 230° C. or lower.

The terminal modified polyethylene terephthalate resin can be produced by Batch polymerization, semi-continuous polymerization, or continuous polymerization.

In the method of producing the terminal modified polyethylene terephthalate resin, compounds of, for example, manganese, cobalt, zinc, titanium, and calcium are used as catalysts for the esterification reaction. The esterification reaction can also be carried out without a catalyst. As catalysts for the transesterification reaction, compounds of, for example, magnesium, manganese, calcium, cobalt, zinc, lithium, and titanium are used. As catalysts for the polycondensation reaction, compounds of, for example, antimony, titanium, aluminum, tin and germanium are used.

Examples of antimony compounds include oxides of antimony, antimony carboxylates and antimony alkoxides. Examples of oxides of antimony include antimony trioxide and antimony pentoxide. Examples of antimony carboxylates include antimony acetate, antimony oxalate and antimony potassium tartrate. Examples of antimony alkoxides include antimony tri-n-butoxide and antimony triethoxide.

Examples of titanium compounds include titanium complexes, titanium alkoxides such as tetra-i-propyl titanate, tetra-n-butyl titanate, and tetra-n-butyl titanate tetramers, titanium oxides obtained by hydrolysis of titanium alkoxides, and titanium acetylacetonate. In particular, titanium complexes containing polycarboxylic acids and/or hydroxycarboxylic acids and/or polyhydric alcohols as chelating agents are preferred to provide polymers with thermal stability and prevent color degradation. Examples of chelating agents in the titanium compounds include lactic acid, citric acid, mannitol and tripentaerythritol.

Examples of aluminum compounds include aluminum carboxylates, aluminum alkoxides, aluminum chelate compounds, and basic aluminum compounds. Specific examples include aluminum acetate, aluminum hydroxide, aluminum carbonate, aluminum ethoxide, aluminum isopropoxide, aluminum acetylacetonate, and basic aluminum acetate.

Examples of tin compounds include monobutyltin oxide, dibutyltin oxide, methylphenyltin oxide, tetraethyltin oxide, hexaethylditin oxide, triethyltin hydroxide, monobutylhydroxytin oxide, monobutyltin trichloride, and dibutyltin sulfide.

Examples of germanium compounds include germanium oxides and germanium alkoxides. Specifically, germanium oxides include germanium dioxide and germanium tetroxide, and germanium alkoxides include germanium tetraethoxide and gemianium tetrabutoxide.

Specific examples of magnesium compounds include magnesium oxide, magnesium hydroxide, magnesium alkoxide, magnesium acetate, and magnesium carbonate.

Specific examples of manganese compounds include manganese chloride, manganese bromide, manganese nitrate, manganese carbonate, manganese acetylacetonate, and manganese acetate.

Specific examples of calcium compounds include calcium oxide, calcium hydroxide, calcium alkoxide, calcium acetate, and calcium carbonate.

Specific examples of cobalt compounds include cobalt chloride, cobalt nitrate, cobalt carbonate, cobalt acetylacetonate, cobalt naphthenate, and cobalt acetate tetrahydrate.

Specific examples of zinc compounds include zinc oxide, zinc alkoxide, and zinc acetate.

These metal compounds may be hydrates.

The terminal modified polyethylene terephthalate resin may contain a phosphorus compound serving as a stabilizer. Specific examples include phosphoric acid, trimethyl phosphate, triethyl phosphate, ethyl diethylphosphonoacetate, 3,9-bis(2,6-di-t-butyl-4-methylphenoxy)-2,4,8,10-tetraoxa-3,9-diphosphaspiro [5,5]undecane, and tetrakis (2,4-di-t-butyl-5-methylphenyl) [1,1-biphenyl]-4,4′-diylbisphosphonate. Preferred are trivalent phosphorus compounds such as 3 ,9-bis (2,6-di-t-butyl-4-methylphenoxy)-2,4,8,10-tetraoxa-3,9-diphosphaspiro[5,5]undecane (PEP36 available from Asahi Denka Kogyo K.K.) and tetrakis(2,4-di-t-butyl-5-methylphenyl)[1,1-biphenyl]-4,4 -diylbisphosphonate (GSY-P 101 available from Osaki Industry Co., Ltd.), which provide excellent color and highly improved thermal stability.

The terminal modified polyethylene terephthalate resin may contain an antioxidant. Specific examples of antioxidants include, but are not limited to, hindered phenolic, sulfur-based, hydrazine-based, and triazole-based antioxidants. These may be used alone or in a combination of two or more.

Examples of hindered phenolic antioxidants include pentaerythritol tetrakis[3-(3,5-di-t-butyl-4-hydroxyphenyl)propionate], thiodiethylenebis[3 -(3,5-di-t-butyl-4-hydroxyphenyl)propionate], octadecyl-3-(3,5-di-t-butyl-4-hydroxyphenyl)propionate, and 4,6-bis(octylthiomethyl)-o-cresol. In particular, pentaerythritol tetrakis[3-(3,5-di-t-butyl-4-hydroxyphenyl)propionate](IRGANOX1010 available from Ciba Japan K. K.), which effectively prevents coloring, is preferred.

Examples of sulfur-based antioxidants include dilauryl thiodipropionate, ditridecyl thiodipropionate, dimyristyl thiodipropionate, distearyl thiodipropionate, pentaerythritol-tetrakis (3-laurylthiopropionate), and pentaerythritol-tetrakis(3-dodecylthiopropionate).

Examples of hydrazine-based antioxidants include decamethylene dicarboxylic acid-bis (N′-salicyloyl hydrazide), isophthalic acid bis(2-phenoxypropionyl hydrazide), and N-formyl-N′-salicyloyl hydrazine.

Examples of triazole-based antioxidants include benzotriazole and 3-(N-salicyloyl) amino-1,2,4-triazole.

Furthermore, dyes used in resins and other materials as color adjusters may optionally be added. Specific examples in COLOR INDEX GENERIC NAME include SOLVENT BLUE 104, SOLVENT BLUE 45 (blur color adjusters), and SOLVENT VIOLET 36 (violet color adjuster), which are preferred because of having high heat resistance at high temperatures and excellent color-developing property. These may be used alone or in a combination of two or more.

In processing the terminal modified polyethylene terephthalate resin into various products, one or more various additives such as fluorescent brightening agents including pigments and dyes, colorants, lubricants, antistatic agents, flame retardants, UV absorbers, antibacterial agents, nucleating agents, delusterants, plasticizers, release agents, antifoaming agents, and other additives, may optionally be added to the extent that the desired effects are not adversely affected.

The terminal modified polyethylene terephthalate resin, for its high melt processability due to a low melt viscosity, can be melt processed into various products such as fibers, films, bottles, and injection-molded articles, using any known method. For example, the terminal modified polyethylene terephthalate resin can be processed into fibers using a commonly used melt-spinning and drawing process. Specifically, the terminal modified polyethylene terephthalate resin can be melted by heating to above the melting point of the terminal modified polyethylene terephthalate resin, discharged through a spinneret, solidified by cooling air, provided with an oil solution, taken up with a take-up roller, and wound up with a wind-up device disposed downstream of the take-up roller to collect an undrawn yarn.

The undrawn yarn wound up in this manner is drawn with at least one pair of heated rollers and, finally, subjected to a tension or relaxation heat treatment to give a fiber provided with physical properties such as mechanical properties, desired for the intended use. This drawing process can be performed continuously without winding up the yarn taken up in the melt-spinning process described above. From the industrial viewpoint, for example, from the viewpoint of productivity, continuous drawing is preferred. In this drawing-heating treatment, a draw ratio, a drawing temperature, and heat treatment conditions can be appropriately selected according to the desired fineness, strength, elasticity, shrinkage, and other properties of the fiber.

A method of processing the terminal modified polyethylene terephthalate resin into a film will now be described in detail. While an example will be described in which a low-density undrawn film is prepared by rapid cooling and then subjected to sequential biaxial drawing, this example is not intended to be limiting.

The terminal modified polyethylene terephthalate resin is dried under vacuum by heating at 180° C. for at least 3 hours and then fed to a single-or twin-screw extruder heated to 270° C. to 320° C. under a stream of nitrogen or under vacuum, which is for preventing the decrease in intrinsic viscosity, to plasticize the polymer. The polymer is melt extruded through a slit die and solidified by cooling on a casting roll to give an undrawn film. In this process, it is preferable to use various filters, for example, filters made of sintered metal, porous ceramic, sand, wire net, and other materials, to remove foreign matter and modified polymers. In addition, a gear pump may optionally be used to provide an improved constant feed. The sheet-like material farmed as described above is then biaxially drawn in the longitudinal direction and the width direction and heat treated. Examples of the drawing method include sequential biaxial drawing, in which drawing is carried out, for example, in the longitudinal direction and then in the width direction; simultaneous biaxial drawing, in which drawing is carried out simultaneously in the longitudinal direction and the width direction using, for example, a simultaneous biaxial tenter; and combinations of the sequential biaxial drawing and the simultaneous biaxial drawing. To control the coefficient of thermal expansion and the degree of heat shrinkage to be in our ranges, the heat treatment after the drawing process is preferably carried out not excessively but effectively so as not to relax the oriented molecular chain.

Having high melt processability due to a reduction effect of melt viscosity, the terminal modified polyethylene terephthalate resin can readily be processed into articles having thin-walled portions with thicknesses of 0.01 to 1.0 mm, articles of complex shape, and large molded articles that require flowability and good appearances.

### EXAMPLES

Our resins, methods and molded articles will now be described in detail with reference to examples.

### (1) Intrinsic Viscosity

A sample was dissolved in an o-chlorophenol solvent to prepare solutions each having a concentration of 0.5 g/dL, 0.2 g/dL, and 0.1 g/dL. After that, the relative viscosity (ηr) at 25° C. of the solution of concentration C was measured with an Ubbelohde viscometer, and (ηr-1)/C was plotted against C. The measurement was extrapolated to zero concentration to determine an intrinsic viscosity.

### (2) Weight Average Molecular Weight, Number Average Molecular Weight, Polydispersity

The weight average molecular weights (Mw) and the number average molecular weights (Mn) of a terminal unmodified polyethylene terephthalate resin and a terminal modified polyethylene terephthalate resin were determined by gel permeation chromatography (GPC). The values of these average molecular weights are expressed in terms of standard polymethyl methacrylate. Polydispersity is a value represented by the ratio (Mw/Mn) of weight average molecular weight (Mw) to number average molecular weight (Mn). A WATERS410 differential refractometer available from WATERS was used as a detector; a MODEL510 high-performance liquid chromatography as a pump; and two Shodex GPC HFIP-806M columns and a Shodex GPC HFIP-LG column as a column. Using a hexafluoroisopropanol solvent (with 0.005 N sodium trifluoroacetate added), a solution at a sample concentration of 1 mg/mL was prepared. At a flow rate of 1.0 mL/min, 0.1 mL of the solution was injected to make an analysis.

### (3) Melt Viscosity μ

In a nitrogen atmosphere, 0.5 g of a sample dried in a vacuum desiccator at 130° C. for at least 12 hours was melted at 300° C. for 5 minutes, and its melt viscosity μ(Pa·s) was measured using a rheometer (MCR501 available from Anton Paar) in the oscillatory mode at a frequency of 3.0 Hz and an amplitude of 20%.

(4) ¹H-NMR Measurement (Quantification of Introduction of Compound (B) into Polymer Terminal)

Using an FT-NMR JNM-AL400 available from JEOL Ltd., ¹H-NMR measurement was carried out with 256 scans. Deuterated HFIP was used as a solvent for measurement, and a solution at a sample concentration of 50 mg/mL was used. The integrated intensity of peaks attributed to R¹ and R² moieties of the compound represented by formula (B) and a peak attributed to polyethylene terephthalate components, the main backbone of the terminal modified polyethylene terephthalate resin, was calculated and divided by the numbers of hydrogen atoms in each structural unit to determine a composition ratio, and the amount of introduction (mol/ton) of the compound (B) into the terminal modified polyethylene terephthalate resin was calculated.

### (5) Thermal Properties

Thermal properties were determined using a differential scanning calorimeter (DSC Q20) available from TA Instruments. In a nitrogen atmosphere, 5 mg of a sample was heated from 30° C. to 280° C. at a rate of 10° C./min, held at 280° C. for 3 minutes, and cooled from 280° C. to 30° C. at a rate of 200° C./min The peak top temperature of an exothermic peak observed in this process was used as a cold crystallization temperature Tc, and the area of the exothermic peak as a cold crystallization enthalpy ΔHc. Subsequently, the sample was heated from 30° C. to 280° C. at a rate of 10° C./min The peak top temperature of an endothermic peak observed in this process was used as a melting point Tm, and the peak area of the endothermic peak as a crystal melting enthalpy ΔHm.

### (6) Acid Value

A sample was dissolved in orthocresol and titrated with a 0.02 N aqueous NaOH solution using an automatic titrator (COM-550 available from HIRANUMA SANGYO Co., Ltd).

(7) Introduction Rate of Compound (B) into Polymer Terminal

The introduction rate was calculated by Y×100/X (%) where X (mol/ton) is a total terminal group determined by multiplying a reciprocal of the number average molecular weight determined in (2) by 2,000,000, and Y (mol/ton) is the amount of introduction of the compound (B) into a polymer terminal determined in (4).

### (8) Hydrolysis Resistance

A sample dried in a vacuum desiccator at 130° C. for at least 12 hours was pressed at 280° C. to give a sheet with a thickness of 1 mm Using a highly accelerated stress test chamber available from ESPEC CORP., 50 mg of the sheet was treated under high-humidity conditions of 121° C., 100% RH, and 24 hours, and the weight average molecular weights before and after treatment were determined by the method in (2). The weight average molecular weight retention after treatment relative to the weight average molecular weight before treatment was evaluated as follows: 70% or more, A; 60% to less than 70%, B; less than 60%, C.

### (9) Melt Stability

Using a rheometer (MCR501 available from Anton Paar), 0.5 g of a sample dried in a vacuum desiccator at 130° C. for at least 12 hours was melted in a nitrogen atmosphere at 280° C. for 15 minutes and then oscillated at a frequency of 0.5 to 3.0 Hz and an amplitude of 20%. The weight average molecular weights before and after treatment were determined by the method in (2), and the rate of change in weight average molecular weight before and after treatment was calculated.

### (10) Bleed Out Resistance

A film prepared by hot pressing was placed in a gear oven at 100° C. for 30 minutes, and the conditions of the surface of the film were visually and manually inspected and evaluated as follows: no change is observed in surface conditions, A; almost no change is observed in surface conditions, B; a slight liquid or powdery substance is observed on the surface, or feels slightly sticky or powdery, C; an apparent liquid or powdery substance is observed on the surface, or feels apparently sticky or powdery, D.

### (11) Drawing Property

A sample dried in a vacuum desiccator at 130° C. for at least 12 hours was pressed at 280° C. to give a pressed film with a thickness of 0.1 mm Using an automatic biaxial drawing machine (IMOTO MACHINERY CO., LTD.), and simultaneous biaxial drawing (drawing ratio: 3×3) was performed at drawing temperatures shown in Tables 1 and 2 and a drawing rate of 60%/min. Films that were drawn without a tear were evaluated as A, and those that had a tear as B.

### (12) Viscoelasticity Measurement

The drawn film obtained in (11) was heat treated in a gear oven at 210° C. for one minute while being fixed so as not to heat-shrink. From the heat-treated film, a test piece 40 mm in length and 8 m in width was cut out. Using a DMS6100 available from Seiko Instruments Inc. in the tensile mode, the dynamic viscoelasticity was measured at a frequency of 1 Hz, a chuck distance of 20 mm, a heating rate of 2° C./min, and 10° C. to 150° C. to determine the storage modulus at 25° C.

### Production Example 1

Magnesium acetate in an amount of 60 ppm (in terms of magnesium atoms) based on the amount of polymer to be obtained, 100 g of dimethyl terephthalate, and 59.2 g of ethylene glycol were melted at 150° C. in a nitrogen atmosphere. The resulting mixture was then heated to 240° C. with stirring over 4 hours to distill out methanol, thereby effecting transesterification reaction to produce bis(hydroxyethyl) terephthalate.

### Example 1

The esterification reactor containing 110 g of the bis(hydroxyethyl) terephthalate obtained in Production Example 1 was kept at 250° C., and then a slurry of 143 g of terephthalic acid, 61.5 g of ethylene glycol, and 12.7 g of the compound having a (poly)oxyalkylene structure and represented by formula (B), as shown in Table 1, (the amount of the compound represented by formula (B) is 4.0 parts by weight based on 100 parts by weight of the total amount of bis(hydroxyethyl) terephthalate, terephthalic acid, and ethylene glycol) were gradually fed to the reactor over four hours. After the completion of feeding, the esterification reaction was effected for one hour to yield an esterification reaction product.

The esterification reaction product obtained was placed in a test tube and kept molten at 250° C., and then antimony trioxide in an amount of 250 ppm (in terms of antimony atoms), phosphoric acid in an amount of 50 ppm (in terms of phosphorus atoms), and cobalt acetate in an amount of 6 ppm (in terms of cobalt atoms), the amounts being based on the amount of polymer to be obtained, were added in the form of a solution in ethylene glycol. The pressure in the reaction system was then reduced with stirring at 90 rpm to initiate the reaction. The temperature in the reactor was gradually raised from 250° C. to 290° C. while the pressure was reduced to 110 Pa. The times until the maximum temperature and the final pressure were reached were both 60 minutes. When a predetermined stirring torque was reached, the reaction system was purged with nitrogen and brought back to normal pressure to stop the polycondensation reaction, and the reaction product was discharged in strands, cooled, and then immediately cut into polymer pellets. The time from the start of depressurization until the predetermined stirring torque was reached was three hours flat. The properties of terminal modified polyethylene terephthalate resins obtained are shown in Tables 1 and 2. The solution of terminal modified polyethylene terephthalate resin in hexafluoroisopropanol was gradually added into methanol under stirring, the amount of methanol being 10 times that of the solution, to cause reprecipitation, whereby the compound of formula (B) left unreacted was removed. The precipitate was recovered and dried in a vacuum desiccator at room temperature for at least 3 hours. From the NMR spectrum of the polymer purified by the reprecipitation, the compound of formula (B) introduced into a polymerterminal was quantitatively determined.

### Examples 2 to 15 and Comparative Examples 1 to 10

The same procedure as in Example 1 was repeated except that the type of the compound used and the production conditions were changed as shown in Table 1 to Table 4.

### Example 16

A terminal unmodified polyethylene terephthalate resin (IV=0.65, Mw=33,000) in an amount of 100 parts by weight and the compound represented by formula (B) in an amount of 4.0 parts by weight were preblended. The blending was fed to a twin-screw extruder (Model PCM-30 available from Ikegai Tekko Co., Ltd.) set at a cylinder temperature of 280° C. and a screw speed of 200 rpm and melt kneaded. A gut extruded was pelletized to give polymer pellets. The pellets of terminal modified polyethylene terephthalate resin were dissolved in hexafluoroisopropanol, and then the resulting solution containing the terminal modified polyethylene terephthalate resin was gradually added into methanol under stirring, the amount of methanol being 10 times that of the solution, to cause reprecipitation. The precipitate was recovered and dried in a vacuum desiccator at room temperature for at least 3 hours. The compound (B) introduced into a polymer terminal determined from the NMR spectrum of the polymer purified by the reprecipitation was 53% of that of Example 1.

### Comparative Exmaple 11

The same procedure as in Example 1 was repeated except that trimethyl 1,3,5-benzenetricarboxylate was added in an amount of 1 part by weight based on 100 parts by weight of the total amount of bis(hydroxyethyl) terephthalate, terephthalic acid, and ethylene glycol.

### Comparative Example 12

The same procedure as in Example 1 was repeated except that R², the reactive functional group of the compound represented by formula (B), was changed from hydroxyl to epoxy.

As shown in Tables 1 and 2, the terminal modified polyethylene terephthalate resins of Examples 1 to 15 each had a low melt viscosity, high melt stability, and a high melting point, compared to the terminal unmodified polyethylene terephthalate resins of Comparative Examples 1 to 3.

In Comparative Example 6, R² of the compound used was a non-reactive functional group, which could not bind to a polymer terminal, thus resulting in a small reduction effect of melt viscosity and poor bleed out resistance.

In Comparative Example 7, m of the compound used was 4, that is, the alkylene chain length was long, and the proportion of the ether linkage in the terminal portion was small, thus resulting in a small reduction effect of melt viscosity.

In Comparative Example 8, the polymerization did not proceed sufficiently due to the low polymerization temperature, thus resulting in a low intrinsic viscosity. In addition, the reduction effect of melt viscosity was small, and the melting point was low.

In Comparative Example 9, n of the compound used was 45, that is, the polyalkyleneoxy chain was long, thus resulting in low melt stability.

In Comparative Example 10, R² of the compound used was hydroxyl, a reactive functional group. Thus, the compound was bound mainly within the polymer backbone, and the terminals of the polyoxyalkylene structure were constrained, thus resulting in a small reduction effect of melt viscosity. Furthermore, the copolymerization reduced the melting point.

In Comparative Example 11, the branch structure formation due to the addition of trimethyl 1,3,5-benzenetricarboxylate resulted in a low melting point and low melt stability.

In Comparative Example 12, the polymer gelled to cling to a stirring blade during the polymerization condensation reaction, resulting in the loss of melt flowability. Since the polymer obtained did not dissolve in a solvent, the polymer could not be analyzed or evaluated for its properties.

TABLE 1

| | | | Examples | | | |
|---|---|---|---|---|---|---|
| | | | 1 | 2 | 3 | 4 |
| Compound having | Added amount | Parts by weight | 4.0 | 4.6 | 3.2 | 2.5 |
| (poly)oxyalkylene | R¹ | Type | Methyl | Methyl | Methyl | Methyl |
| structure shown by | R² | Type | Hydroxyl | Hydroxyl | Hydroxyl | Hydroxyl |
| Formula (B) | m | | 1 | 1 | 1 | 1 |
| | n | | 16 | 16 | 16 | 16 |
| | X | Type | H | H | H | H |
| | Y | Type | H | H | H | H |
| | Total carbon number excluding carbon number of R¹ and R² | | 32 | 32 | 32 | 32 |
| Added timing of the compound (B)* | | | (a) | (a) | (a) | (a) |
| Esterification | Temperature | ° C. | 250 | 250 | 250 | 250 |
| reaction | Total time | Hour | 5 | 5 | 5 | 5 |
| Polycondensation | Temperature | ° C. | 290 | 290 | 290 | 290 |
| reaction | Time from reduced pressure to extruding | Hour | 3 | 3 | 3 | 3 |
| Polymer | Intrinsic viscosity | dl/g | 0.62 | 0.68 | 0.66 | 0.68 |
| | Introducing amount of compound (B) into polymer end terminal | mol/ton | 51.6 | 71.0 | 44.3 | 34.3 |
| | | Weight % | 3.8 | 5.2 | 3.3 | 2.5 |
| | Introducing rat of compound (B) into polymer end terminal | % | 45 | 74 | 41 | 32 |
| | 300° C. melt viscosity μ | Pa · s | 9 | 8 | 14 | 22 |
| | 4 × e^{(0.000085×Mw)} | — | 56 | 78 | 72 | 78 |
| | Weight average molecular weight Mw | — | 31000 | 35000 | 34000 | 35000 |
| | Number average molecular weight Mn | — | 17400 | 20800 | 18700 | 18500 |
| | Dispersivity | — | 1.78 | 1.68 | 1.82 | 1.89 |
| | Cooling crystallization temperature Tc | ° C. | 194 | 196 | 187 | 176 |
| | Cooling crystallization calorimetry ΔHc | J/g | 51 | 53 | 50 | 52 |
| | Melting point Tm | ° C. | 256 | 255 | 254 | 255 |
| | Crystallization fusion calorimetry ΔHm | J/g | 51 | 49 | 48 | 50 |
| | Acid value | mol/ton | 7 | 6 | 12 | 12 |
| | Melt retaining stability | % | 99 | 98 | 99 | 98 |
| | Hydrolysis resistance | — | A | A | A | A |
| | Bleed out resistance | — | A | A | A | A |
| | | | Examples | | | |
| | | | 5 | 6 | 7 | 8 |
| Compound having | Added amount | Parts by weight | 2.5 | 6.1 | 4.0 | 4.0 |
| (poly)oxyalkylene | R¹ | Type | Methyl | Methyl | Methyl | Methyl |
| structure shown by | R² | Type | Hydroxyl | Hydroxyl | Hydroxyl | Hydroxyl |
| Formula (B) | m | | 1 | 1 | 2 | 3 |
| | n | | 8 | 22 | 12 | 8 |
| | X | Type | H | H | H | H |
| | Y | Type | H | H | H | H |
| | Total carbon number excluding carbon number of R¹ and R² | | 16 | 44 | 36 | 32 |
| Added timing of the compound (B)* | | | (a) | (a) | (a) | (a) |
| Esterification | Temperature | ° C. | 250 | 250 | 250 | 250 |
| reaction | Total time | Hour | 5 | 5 | 5 | 5 |
| Polycondensation | Temperature | ° C. | 290 | 290 | 290 | 290 |
| reaction | Time from reduced pressure to extruding | Hour | 3 | 3 | 3 | 3 |
| Polymer | Intrinsic viscosity | dl/g | 0.60 | 0.65 | 0.62 | 0.61 |
| | Introducing amount of compound (B) into polymer end terminal | mol/ton | 58.5 | 62.0 | 50.2 | 60.1 |
| | | Weight % | 2.2 | 6.2 | 3.7 | 3.7 |
| | Introducing rat of compound (B) into polymer end terminal | % | 48 | 58 | 42 | 50 |
| | 300° C. melt viscosity μ | Pa · s | 13 | 7 | 20 | 28 |
| | 4 × e^{(0.000085×Mw)} | — | 47 | 66 | 56 | 51 |
| | Weight average molecular weight Mw | — | 29000 | 33000 | 31000 | 30000 |
| | Number average molecular weight Mn | — | 16500 | 18600 | 16800 | 16800 |
| | Dispersivity | — | 1.76 | 1.77 | 1.85 | 1.79 |
| | Cooling crystallization temperature Tc | ° C. | 196 | 193 | 184 | 182 |
| | Cooling crystallization calorimetry ΔHc | J/g | 51 | 51 | 50 | 49 |
| | Melting point Tm | ° C. | 257 | 254 | 254 | 253 |
| | Crystallization fusion calorimetry ΔHm | J/g | 49 | 49 | 50 | 50 |
| | Acid value | mol/ton | 10 | 8 | 11 | 12 |
| | Melt retaining stability | % | 99 | 97 | 98 | 98 |
| | Hydrolysis resistance | — | A | A | A | A |
| | Bleed out resistance | — | A | A | A | A |

*(a) Esterification reaction step, (b) Ester exchange reaction step, (c) Polycondensation reaction step

TABLE 2

| | | | Examples | | | |
|---|---|---|---|---|---|---|
| | | | 9 | 10 | 11 | 12 |
| Compound having | Added amount | Parts by weight | 4.0 | 5.0 | 4.0 | 4.0 |
| (poly)oxyalkylene | R¹ | Type | Methyl | Stearyl | Methyl | Methyl |
| structure shown by | R² | Type | Hydroxyl | Hydroxyl | Carboxyl | Hydroxyl |
| Formula (B) | m | | 1 | 1 | 1 | 1 |
| | n | | 12 | 17 | 16 | 16 |
| | X | Type | CH₃ | H | H | H |
| | Y | Type | H | H | H | H |
| | Total carbon number excluding carbon number of R¹ and R² | | 36 | 34 | 32 | 32 |
| Added timing of the compound (B)* | | | (a) | (a) | (a) | (a) |
| Esterification | Temperature | ° C. | 250 | 250 | 250 | 240 |
| reaction | Total time | Hour | 5 | 5 | 5 | 5 |
| Polycondensation | Temperature | ° C. | 290 | 290 | 290 | 290 |
| reaction | Time from reduced pressure to extruding | Hour | 3 | 3 | 3 | 3 |
| Polymer | Intrinsic viscosity | dl/g | 0.65 | 0.62 | 0.66 | 0.58 |
| | Introducing amount of compound (B) into polymer end terminal | mol/ton | 52.6 | 47.3 | 54.5 | 45.6 |
| | | Weight % | 3.8 | 4.8 | 4.0 | 3.4 |
| | Introducing rat of compound (B) into polymer end terminal | % | 46 | 42 | 50 | 35 |
| | 300° C. melt viscosity μ | Pa · s | 23 | 9 | 19 | 7 |
| | 4 × e^{(0.000085×Mw)} | — | 66 | 56 | 72 | 43 |
| | Weight average molecular weight Mw | — | 33000 | 31000 | 34000 | 28000 |
| | Number average molecular weight Mn | — | 17600 | 17600 | 18400 | 15400 |
| | Dispersivity | — | 1.88 | 1.76 | 1.85 | 1.82 |
| | Cooling crystallization temperature Tc | ° C. | 185 | 192 | 181 | 192 |
| | Cooling crystallization calorimetry ΔHc | J/g | 52 | 51 | 51 | 49 |
| | Melting point Tm | ° C. | 255 | 254 | 254 | 253 |
| | Crystallization fusion calorimetry ΔHm | J/g | 48 | 49 | 50 | 48 |
| | Acid value | mol/ton | 13 | 9 | 17 | 10 |
| | Melt retaining stability | % | 97 | 99 | 97 | 99 |
| | Hydrolysis resistance | — | A | A | B | A |
| | Bleed out resistance | — | B | A | A | B |
| | | | Examples | | | |
| | | | 13 | 14 | 15 | 16 |
| Compound having | Added amount | Parts by weight | 4.0 | 4.0 | 4.0 | 4.0 |
| (poly)oxyalkylene | R¹ | Type | Methyl | Methyl | Methyl | Methyl |
| structure shown by | R² | Type | Hydroxyl | Hydroxyl | Hydroxyl | Hydroxyl |
| Formula (B) | m | | 1 | 1 | 1 | 1 |
| | n | | 16 | 16 | 16 | 16 |
| | X | Type | H | H | H | H |
| | Y | Type | H | H | H | H |
| | Total carbon number excluding carbon number of R¹ and R² | | 32 | 32 | 32 | 32 |
| Added timing of the compound (B)* | | | (a) | (b) | (c) | Melt |
| | | | | | | kneading |
| Esterification | Temperature | ° C. | 250 | 250 | 250 | — |
| reaction | Total time | Hour | 5 | 5 | 5 | — |
| Polycondensation | Temperature | ° C. | 280 | 290 | 290 | — |
| reaction | Time from reduced pressure to extruding | Hour | 3 | 3 | 3 | — |
| Polymer | Intrinsic viscosity | dl/g | 0.57 | 0.61 | 0.62 | 0.68 |
| | Introducing amount of compound (B) into polymer end terminal | mol/ton | 45.0 | 48.1 | 51.6 | 27.2 |
| | | Weight % | 3.3 | 3.5 | 3.8 | 2.0 |
| | Introducing rat of compound (B) into polymer end terminal | % | 34 | 39 | 45 | 25 |
| | 300° C. melt viscosity μ | Pa · s | 8 | 9 | 26 | 63 |
| | 4 × e^{(0.000085×Mw)} | — | 40 | 51 | 56 | 78 |
| | Weight average molecular weight Mw | — | 27000 | 30000 | 31000 | 35000 |
| | Number average molecular weight Mn | — | 15200 | 16200 | 16800 | 18300 |
| | Dispersivity | — | 1.78 | 1.85 | 1.78 | 1.91 |
| | Cooling crystallization temperature Tc | ° C. | 189 | 192 | 193 | 172 |
| | Cooling crystallization calorimetry ΔHc | J/g | 50 | 48 | 50 | 48 |
| | Melting point Tm | ° C. | 255 | 255 | 254 | 253 |
| | Crystallization fusion calorimetry ΔHm | J/g | 51 | 50 | 49 | 49 |
| | Acid value | mol/ton | 6 | 8 | 7 | 19 |
| | Melt retaining stability | % | 97 | 99 | 99 | 107 |
| | Hydrolysis resistance | — | A | A | A | B |
| | Bleed out resistance | — | A | B | B | D |

*(a) Esterification reaction step, (b) Ester exchange reaction step, (c) Polycondensation reaction step

TABLE 3

| | | | Comparative Examples | | | | | | |
|---|---|---|---|---|---|---|---|---|---|
| | | | 1 | 2 | 3 | 4 | 5 | 6 | 7 |
| Compound | Added amount | Parts by | — | — | — | 0.3 | 8.0 | 4.0 | 4.0 |
| having | | weight | | | | | | | |
| (poly)oxyalkylene | R¹ | Type | — | — | — | Methyl | Methyl | Methyl | Methyl |
| structure | R² | Type | — | — | — | Hydroxyl | Hydroxyl | Methyl | Hydroxyl |
| shown by | m | | — | — | — | 1 | 1 | 1 | 4 |
| Formula (B) | n | | — | — | — | 16 | 16 | 16 | 10 |
| | X | Type | | — | — | H | H | H | H |
| | Y | Type | — | — | — | H | H | H | H |
| | Total carbon number excluding | | — | — | — | 32 | 32 | 32 | 50 |
| | carbon number of R¹ and R² | | | | | | | | |
| Added timing of the compound (B)* | | | — | — | — | (a) | (a) | (a) | (a) |
| Esterification | Temperature | ° C. | 250 | 250 | 250 | 250 | 250 | 250 | 250 |
| reaction | Total time | Hour | 5 | 5 | 5 | 5 | 5 | 5 | 5 |
| Polycondensation | Temperature | ° C. | 290 | 280 | 270 | 290 | 290 | 290 | 290 |
| reaction | Time from reduced pressure | Hour | 3.0 | 3.0 | 4.5 | 3 | 3 | 3.0 | 3.0 |
| Polymer | to extruding | | | | | | | | |
| | Intrinsic viscosity | dl/g | 0.65 | 0.46 | 0.81 | 0.62 | 0.35 | 0.62 | 0.64 |
| | Introducing amount of compound | mol/ton | 0.0 | 0.0 | 0.0 | 3.5 | 103 | 0.0 | 57.2 |
| | (B) into polymer end terminal | Weight % | 0.0 | 0.0 | 0.0 | 0.3 | 7.6 | 0.0 | 5.1 |
| | Introducing rat of compound (B) | % | 0 | 0 | 0 | 3 | 40 | 0 | 46 |
| | into polymer end terminal | | | | | | | | |
| | 300° C. melt viscosity μ | Pa · s | 157 | 54 | 463 | 120 | 5 | 80 | 112 |
| | 4 × e^{(0.000085×Mw)} | — | 66 | 22 | 200 | 56 | 12 | 56 | 61 |
| | Weight average molecular | — | 33000 | 20000 | 46000 | 31000 | 13000 | 31000 | 32000 |
| | weight Mw | | | | | | | | |
| | Number average molecular | — | 16100 | 9950 | 19700 | 15700 | 7830 | 14800 | 16100 |
| | weight Mn | | | | | | | | |
| | Dispersivity | — | 2.05 | 2.01 | 2.33 | 1.97 | 1.66 | 2.10 | 1.99 |
| | Cooling crystallization | ° C. | 166 | 162 | 163 | 166 | 179 | 169 | 173 |
| | temperature Tc | | | | | | | | |
| | Cooling crystallization | J/g | 49 | 45 | 46 | 50 | 49 | 50 | 51 |
| | calorimetry ΔHc | | | | | | | | |
| | Melting point Tm | ° C. | 254 | 238 | 254 | 255 | 235 | 255 | 256 |
| | Crystallization fusion | J/g | 50 | 45 | 50 | 49 | 48 | 48 | 50 |
| | calorimetry ΔHm | | | | | | | | |
| | Acid value | mol/ton | 17 | 15 | 26 | 14 | 7 | 17 | 14 |
| | Melt retaining stability | % | 125 | 99 | 105 | 99 | 87 | 128 | 112 |
| | Hydrolysis resistance | — | B | B | C | B | A | B | B |
| | Bleed out resistance | — | A | A | A | A | A | D | A |

*(a) Esterification reaction step, (b) Ester exchange reaction step, (c) Polycondensation reaction step

TABLE 4

| | | | Comparative Examples | | | |
|---|---|---|---|---|---|---|
| | | | 8 | 9 | 10 | 11 |
| Compound having | Added amount | Parts by weight | 4.0 | 10.4 | 4.0 | 34.0 |
| (poly)oxyalkylene | R¹ | Type | Methyl | Methyl | Hydroxyl | Methyl |
| structure shown by | R² | Type | Hydroxyl | Hydroxyl | Hydroxyl | Hydroxyl |
| Formula (B) | m | | 1 | 1 | 1 | 1 |
| | n | | 16 | 45 | 16 | 16 |
| | X | Type | H | H | H | H |
| | Y | Type | H | H | H | H |
| | Total carbon number excluding carbon | | 32 | 90 | 32 | 32 |
| | number of R¹ and R² | | | | | |
| Added timing of the compound (B)* | | | (a) | (a) | (a) | (a) |
| Esterification | Temperature | ° C. | 250 | 250 | 250 | 250 |
| reaction | Total time | Hour | 5 | 5 | 5 | 5 |
| Polycondensation | Temperature | ° C. | 275 | 290 | 290 | 290 |
| reaction | Time from reduced pressure to extruding | Hour | 2.0 | 3.0 | 2.0 | 3.0 |
| Polymer | Intrinsic viscosity | dl/g | 0.42 | 0.61 | 0.62 | 1.12 |
| | Introducing amount of compound (B) into | mol/ton | 29.1 | 41.4 | unmeasurable | 69.3 |
| | polymer end terminal | Weight % | 2.1 | 8.3 | unmeasurable | 5.1 |
| | Introducing rat of compound (B) into | % | 14 | 34 | unmeasurable | unmeasurable |
| | polymer end terminal | | | | | |
| | 300° C. melt viscosity μ | Pa · s | 20 | 22 | 47 | 51 |
| | 4 × e^{(0.000085×Mw)} | — | 18 | 51 | 56 | 1981 |
| | Weight average molecular weight Mw | — | 17500 | 30000 | 31000 | 73000 |
| | Number average molecular weight Mn | — | 9830 | 16400 | 12400 | 22700 |
| | Dispersivity | — | 1.78 | 1.83 | 2.51 | 3.21 |
| | Cooling crystallization temperature Tc | ° C. | 185 | 182 | 184 | undetectable |
| | Cooling crystallization calorimetry ΔHc | J/g | 44 | 47 | 49 | undetectable |
| | Melting point Tm | ° C. | 240 | 251 | 243 | 235 |
| | Crystallization fusion calorimetry ΔHm | J/g | 44 | 49 | 48 | 32 |
| | Acid value | mol/ton | 9 | 15 | 11 | 8 |
| | Melt retaining stability | % | 98 | 67 | 89 | 58 |
| | Hydrolysis resistance | — | A | B | A | A |
| | Bleed out resistance | — | A | B | A | B |

*(a) Esterification reaction step, (b) Ester exchange reaction step, (c) Polycondensation reaction step

### Example 17 and Comparative Example 13

The polyethylene terephthalate resin obtained in Example 1 or Comparative Example 1 was crystallized in a hot-air dryer at 170° C. for 30 minutes and then pre-dried in a vacuum dryer at 180° C. for two hours. The resulting resin was then placed in a rotary vacuum device (rotary vacuum dryer) under the conditions of a temperature of 220° C. and a reduced pressure of 0.5 mmHg and heated with stirring for a predetermined time to give a highly polymerized polyethylene terephthalate resin. The properties of the polyethylene terephthalate resin are shown in Table 5. The terminal modified polyethylene terephthalate resin subjected to solid phase polymerization of Example 17 had a low melt viscosity and high melt stability and hydrolysis resistance, as compared with the terminal unmodified polyethylene terephthalate resin of Comparative Example 13.

TABLE 5

| | | | | Comparative |
|---|---|---|---|---|
| | | | Example 17 | Example 13 |
| Solid phase | PET resin obtained by melt polymerization | | Example 1 | Comparative |
| polymerization | | | | Example 1 |
| | Temperature | ° C. | 220 | 220 |
| | Polymerization time | Hour | 40 | 24 |
| Polymer | Intrinsic viscosity | dl/g | 1.18 | 1.14 |
| | Introducing amount of compound (B) into polymer end terminal | mol/ton | 43.6 | 0.0 |
| | | wt % | 3.2 | 0.0 |
| | Introducing rate of compound (B) into polymer end terminal | % | 97 | 0 |
| | 300° C. melt viscosity μ | Pa · s | 847 | 4875 |
| | 4 × e^{(0.000085×Mw)} | — | 3299 | 2348 |
| | Weight average molecular weight Mw | — | 79000 | 75000 |
| | Number average molecular weight Mn | — | 44400 | 26800 |
| | Dispersivity | — | 1.78 | 2.80 |
| | Cooling crystallization temperature Tc | ° C. | 176 | 163 |
| | Cooling crystallization calorimetry ΔHc | J/g | 45 | 22 |
| | Melting point Tm | ° C. | 255 | 254 |
| | Crystallization fusion calorimetry ΔHm | J/g | 46 | 45 |
| | Acid value | mol/ton | 9 | 18 |
| | Melt retaining stability | % | 84 | 56 |
| | Hydrolysis resistance | — | A | C |
| | Bleed out resistance | — | A | A |

### Example 18 and Comparative Examples 14 and 15

The terminal modified polyethylene terephthalate resin of Example 1 and the terminal unmodified polyethylene terephthalate resin obtained in Comparative Example 1 were drawn at a predetermined temperature to evaluate their drawing property. Films that could be drawn were heat treated and then subjected to viscoelasticity measurement. The results are shown in Table 6. The comparison of Example 18 with Comparative Examples 14 and 15 shows that the terminal modified polyethylene terephthalate resin could be drawn at a lower temperature and had a higher storage modulus than the terminal unmodified polyethylene terephthalate resins.

TABLE 6

| | | | Comparative | Comparative |
|---|---|---|---|---|
| | | Example 18 | Example 14 | Example 15 |
| Polymer | | Example 1 | Comparative | Comparative |
| | | | Example 1 | Example 1 |
| Draw temperature | ° C. | 70 | 90 | 70 |
| Drawing property | | A | A | B |
| Storage elastic | GPa | 7.8 | 7.0 | unmeasurable |
| modulus (25° C.) | | | | |

### INDUSTRIAL APPLICABILITY

The terminal modified polyethylene terephthalate resin, for its high melt processability due to a low melt viscosity, can be melt processed into various products such as fibers, films, bottles, and injection-molded articles, using any known method. These products are useful for agricultural materials, gardening materials, fishing materials, civil engineering and construction materials, stationery, medical supplies, automobile components, electrical and electronic components or other applications.

1.-14. (canceled)

15. A terminal modified polyethylene terephthalate resin having an intrinsic viscosity of 0.50 to 1.8 dl/g, a melting point of 245° C. to 270° C., and a melt viscosity μ(Pa·s) at 300° C. satisfies inequality (A):
μ≦4×e^{(0.000085×Mw)} (A)
wherein Mw represents a weight average molecular weight relative to a molecular weight of standard polymethyl methacrylate, as determined by gel permeation chromatography using hexafluoroisopropanol (with 0.005 N sodium trifluoroacetate added) as a mobile phase, the terminal modified polyethylene terephthalate resin comprising.
25 to 80 mol/ton of a compound having a (poly)oxyalkylene structure and bound to a terminal, the compound represented by formula (B): 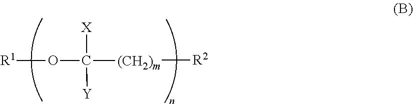
wherein R¹ is at least one selected from alkyl groups of 1 to 30 carbon atoms, cycloalkyl groups of 6 to 20 carbon atoms, aryl groups of 6 to 10 carbon atoms, and aralkyl groups of 7 to 20 carbon atoms; R² is one selected from a hydroxyl group, a carboxyl group, an amino group, a silanol group, and a thiol group; m is an integer of 1 to 3; n is an integer of 1 to 29; X is H and/or CH₃; and Y is H and/or CH₃, provided that the total number of carbons excluding the carbons of R¹ and R² is 2 to 58.

16. The terminal modified polyethylene terephthalate resin according to claim 15, wherein the resin has a crystal melting enthalpy of 45 to 80 J/g, the crystal melting enthalpy being determined by differential scanning calorimetry (DSC) in which the resin is heated from 30° C. to 280° C. at a heating rate of 10° C./min, held at 280° C. for 3 minutes, cooled from 280° C. to 30° C. at a cooling rate of 200° C./min, and heated from 30° C. to 280° C. at a heating rate of 10° C./min.

17. The terminal modified polyethylene terephthalate resin according to claim 15, wherein the resin has a cold crystallization temperature of 170° C. to 210° C., the cold crystallization temperature being determined by differential scanning calorimetry (DSC) in which the resin is heated from 30° C. to 280° C. at a heating rate of 10° C./min, held at 280° C. for 3 minutes, and then cooled from 280° C. to 30° C. at a cooling rate of 200° C./min

18. The terminal modified polyethylene terephthalate resin according to claim 15, wherein the resin has an acid value of 13 mol/ton or less.

19. The terminal modified polyethylene terephthalate resin according to claim 15, wherein the resin has a rate of change in weight average molecular weight of 80% to 120%, the rate of change being determined after the resin is melted under nitrogen at 280° C. for 15 minutes using a rheometer and then oscillated at a frequency of 0.5 to 3.0 Hz and an amplitude of 20%.

20. The terminal modified polyethylene terephthalate resin according to claim 15, wherein the resin has a polydispersity (Mw/Mn), a ratio of weight average molecular weight (Mw) to number average molecular weight (Mn), of 2.5 or less.

21. A molded article comprising the terminal modified polyethylene terephthalate resin according to claim 15.

22. The molded article according to claim 21, wherein the molded article is a fiber or a film.

23. A method of producing a terminal modified polyethylene terephthalate resin from raw materials comprising a compound having a (poly)oxyalkylene structure, ethylene glycol, and terephthalic acid or a terephthalic acid dialkyl ester, the method comprising:
a step comprising an esterification reaction process (a) or a transesterification reaction process (b); and
a subsequent step comprising a polycondensation reaction process (c),
the compound having a (poly)oxyalkylene structure represented by formula (B): 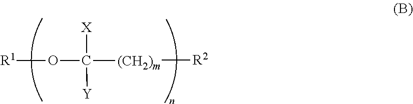
wherein R¹ is at least one selected from alkyl groups of 1 to 30 carbon atoms, cycloalkyl groups of 6 to 20 carbon atoms, aryl groups of 6 to 10 carbon atoms, and aralkyl groups of 7 to 20 carbon atoms; R² is one selected from a hydroxyl group, a carboxyl group, an amino group, a silanol group, and a thiol group; m is an integer of 1 to 3; n is an integer of 1 to 29; X is H and/or CH₃; and Y is H and/or CH₃, provided that the total number of carbons excluding the carbons of R¹ and R² is 2 to 58.

24. The method according to claim 23, wherein the compound represented by formula (B) is added in any process selected from the esterification reaction process (a), the transesterification reaction process (b), and the polycondensation reaction process (c).

25. The method according to claim 24, wherein the compound represented by formula (B) is added in the esterification reaction process (a) or the transesterification reaction process (b) and allowed to react at 230° C. to 260° C.

26. The method according to claim 23, wherein the polycondensation reaction process (c) is performed at a maximum temperature of 280° C. to 300° C.

27. The method according to claim 23, further comprising subjecting the terminal modified polyethylene terephthalate resin obtained by the polycondensation reaction process (c) to solid phase polymerization at a temperature of 200° C. to 240° C.

28. The method according to claim 23, providing a terminal modified polyethylene terephthalate resin having an intrinsic viscosity of 0.50 to 1.8 dl/g, a melting point of 245° C. to 270° C., and a melt viscosity μ(Pa·s) at 300° C. that satisfies inequality (A):
μ≦4×e^{(0.000085×Mw)} (A)
wherein Mw represents a weight average molecular weight relative to a molecular weight of standard polymethyl methacrylate, as determinded by gel permeation chromatography using hexafluoroisopropanol (with 0.005 N sodium trifluoroacetate added) as a mobile phase, the terminal modified polyethylene terephthalate resin comprising
25 to 80 mol/ton of a compound having a (poly)oxyalkylene structure and bound to a terminal, the compound represented by formula (B): 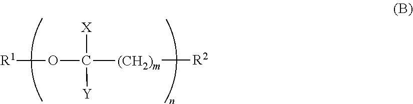
wherein R¹ is at least one selected from alkyl groups of 1 to 30 carbon atoms, cycloalkyl groups of 6 to 20 carbon atoms, aryl groups of 6 to 10 carbon atoms, and aralkyl groups of 7 to 20 carbon atoms; R² is one selected from a hydroxyl group, a carboxyl group, an amino group, a silanol group, and a thiol group; m is an integer of 1 to 3; n is an integer of 1 to 29; X is H and/or CH₃; and Y is H and/or CH₃, provided that the total number of carbons excluding the carbons of R¹ and R² is 2 to 58.
